(19) United States
(12) Patent Application Publication
(10) Pub. No.: US 2013/0316592 A1
(43) Pub. Date: Nov. 28, 2013

(54) ELECTRICAL CARD CONNECTOR

(71) Applicant: Hon Hai Precision Industry Co., Ltd., New Taipei (TW)

(72) Inventors: CHUN-MING YU, Kunshan (CN); JI-CHAO WANG, Kunshan (CN)

(21) Appl. No.: 13/903,006

(22) Filed: May 28, 2013

(30) Foreign Application Priority Data
May 25, 2012 (CN) 201210165783.X

(51) Int. Cl. H01R 13/516

(52) U.S. Cl. CPC H01R 13/516
USPC 439/660

(57) ABSTRACT

An electrical connector 100 includes an insulative housing 1, a set of contacts 3 and a shell 6. The housing 1 includes a base 11 and a tongue 22 extending forwardly from the base 11. The shell 6 and the tongue 22 defines a receiving room 101 for receiving a mating connector. The electrical connector 100 further includes a first and a second detecting terminals 41, 42 retained in the housing 1 and located on two sides of the tongue 22. The first and second detecting terminals 41, 42 comprise a first and a second engaging portions 415, 425 extending into the receiving room 101. The first engaging portion 415 is located in a different position from the second engaging portion 425 along a front-to-rear direction. The electrical connector 100 could detect whether a mating connector is inserted and further detect whether a certain mating connector is inserted.

### BACKGROUND OF THE INVENTION

1. Field of the Invention

The present invention is generally related to an electrical connector, and especially to an electrical connector with a detecting terminal.

2. Description of Related Art

Chinese patent application No. 102082370A discloses a conventional electrical connector, which comprises an insulative housing, a plurality of contacts and a detecting terminal retained in the housing and a metal shell enclosing the housing. The housing defines a retaining slot at a right side thereof for retaining the detecting terminal. The detecting terminal has a securing portion retained in the retaining slot, a soldering portion extending downwardly from one end of the securing portion, a spring arm extending horizontally and forwardly from the other end of the securing portion and a detecting portion extending forwardly from the spring arm. When a mating plug is inserted into the electrical connector, a plug shell of the mating plug electrically contacts with the detecting portion of the detecting terminal to trigger the circuit which connects with the detecting terminal to achieve the detecting function. However, the detecting terminal merely can detect whether the mating plug is inserted but can't detects whether a certain mating plug is inserted.

Hence, an improved electrical connector is highly desired to overcome the aforementioned disadvantages of the prior art.

### SUMMARY OF THE INVENTION

The present invention generally relates to an electrical connector and more particularly to an electrical connector with a detecting terminal.

To achieve the above object, an electrical connector adapted for receiving multiple kinds of mating connector, comprises an insulative housing defining a base and a tongue portion extending forwardly from the base, a plurality of contacts retained in the housing, a metal shell coving the housing and first and second detecting terminals retained in the housing. The tongue portion defines a front end surface, a first surface and a second surface opposite to the first surface. The shell and the tongue portion commonly define a receiving space for receiving the mating connector. The first and second detecting terminals are located at other opposite side surface respectively and define a first and a second engaging portions extending into the receiving space respectively. Wherein the second engaging portion of the second detecting terminal is positioned near to the front end surface while the first engaging portion of the first detecting terminal is positioned on an rear-end of the receiving space and merely electrical contacts with a certain mating connector which is arrived to the rear-end of the receiving space.

Other objects, advantages and novel features of the present invention will be drawn from the following detailed description of a preferred embodiment of the present invention with attached drawings.

### BRIEF DESCRIPTION OF THE DRAWINGS

FIG. 1 is an assembled, perspective view of an electrical connector in accordance with the present invention;

FIG. 2 is a view similar to FIG. 1, while taken from a bottom aspect;

FIG. 3 is an partly exploded, perspective view of the electrical connector in accordance with the present invention;

FIG. 4 is a view similar to FIG. 3, while taken from another aspect;

FIG. 5 is an exploded, perspective view of the electrical connector in accordance with the present invention;

FIG. 6 is a view similar to FIG. 5, while taken from another aspect;

FIG. 7 is a sectional view of the electrical connector, taken along line 7-7 in the FIG. 1;

FIG. 8 is a view similar to FIG. 7, while a ordinary plug is inserted into the electrical connector; and

FIG. 9 is a view similar to FIG. 7, while a power delivery plug is inserted into the electrical connector.

### DETAILED DESCRIPTION OF THE INVENTION

Reference will now be made in detail to the preferred embodiment of the present invention.

Reference will be made to the drawing figures to describe the present invention in detail, wherein depicted elements are not necessarily shown to scale and wherein like or similar elements are designated by same or similar reference numeral through the several views and same or similar terminology.

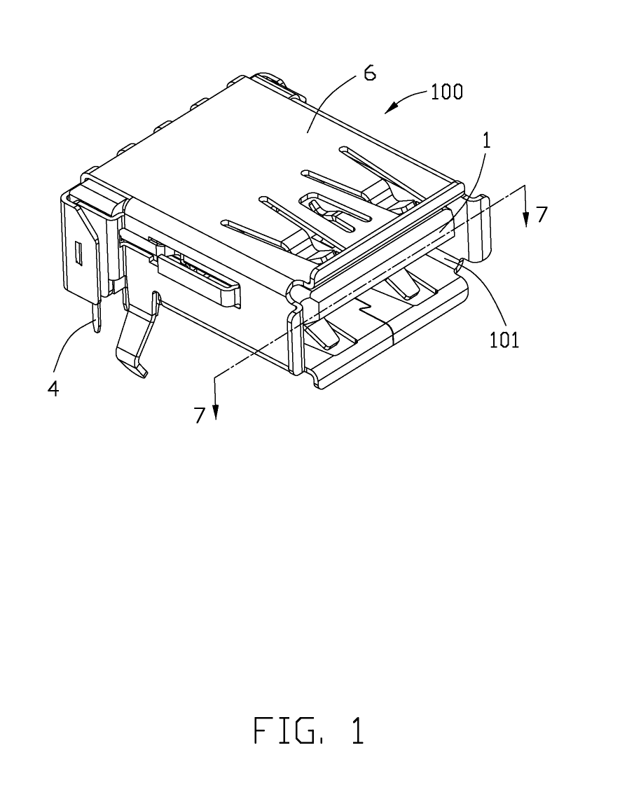

Referring to FIGS. 1-4, an electrical connector 100 is preferably a receptacle adapted for receiving multiple kinds of mating connector. The electrical connector 100 includes an insulative housing 1, a plurality of contacts 3 held in the housing 1, two switch contacts 4 and a spacer 5 assembled to the housing 1 and a metal shell 6 enclosing the housing 1.

Referring to FIGS. 1-6, the housing 1 comprises a first housing 10 and a second housing 20 backwardly assembled to the first housing 10. The housing 1 and the shell 6 commonly define a receiving space 101 (refers to FIG. 1) to mate with a mating connector (not shown). The first housing 10 has a base 11 and a supporting plate 12 extending horizontally and forwardly from a bottom of the base 11. The base 11 comprises a front surface 111, a rear surface 112 opposite to the front surface 111, a pair of side walls 113 located at two lateral sides thereof, a top wall 114 connecting the side walls 113 and a pair of extending portions 115 respectively located on two outside surfaces of the side walls 113.

The base 11 defines a first mounting slot 1111 recessed backwardly from the front surface 111, a pair of second mounting slots 1112 respectively extending downwardly from a left and right sides of the first mounting slot 1111 and extending through the base 11 along a front-to-back direction and a lot of first retaining slots 1113 located below the first mounting slot 1111 and between the pair of second mounting slots 1112. The first retaining slots 1113 backwardly extend through the base 11 and are separated from each other. The base 11 further defines a plurality of second retaining slots 1121 forwardly recessed from the rear surface 112 and connecting with the first mounting slot 1111 and a mounting space 110 recessed forwardly from the rear surface 112 and surrounded by the top wall 114 and two side walls 113. The side wall 113 defines a latching bump 119 protruding inwardly from an inside surface thereof and a holding slot 118 recessed forwardly from a rear surface thereof. A retaining groove 116 is formed between the side wall 113 and the extending portion 115 to retain the switch contact 4.

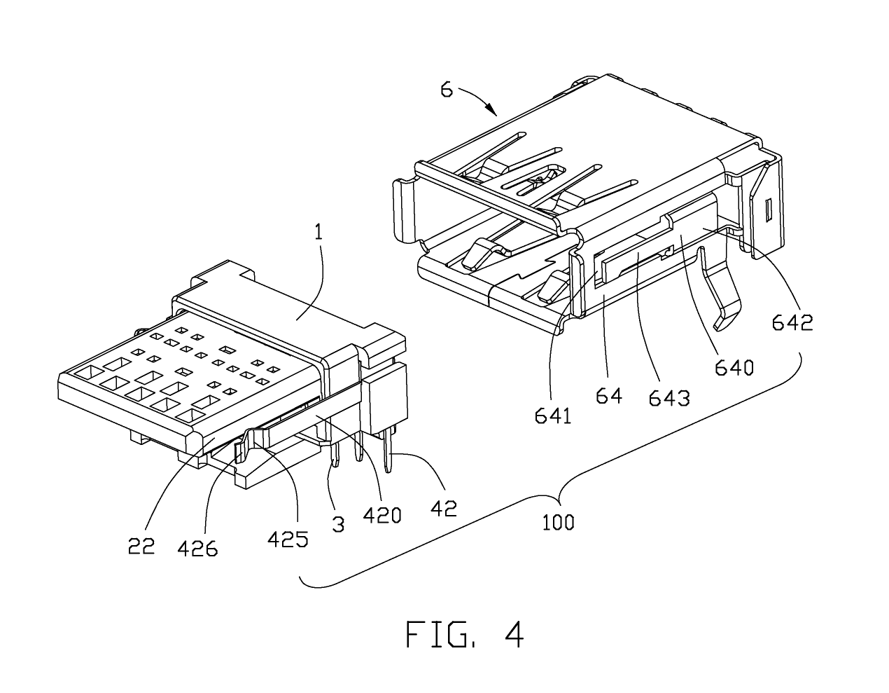

The retaining groove 116 comprises two retaining grooves 116, one is formed between the side wall 113 at a left side of the base 11 and the extending portion 115 at a left side of the base 11, the other one is formed between the side wall 113 at a right side of the base 11 and the extending portion 115 at a right side of the base 11. As shown in FIG. 4, the retaining groove 116 is a reverse L-shaped configuration when be observed from a right-to-left direction. Each retaining groove 116 comprises a receiving slot 1161 extending along a vertical direction, a limiting slot 1162 extending along a horizontal direction and located above the receiving slot 1161 and a mounting slot 1163 extending outwardly from the middle of the limiting slot 1162 and outwardly through the extending portion 115. The receiving slot 1161 backwardly and downwardly extends through the extending portion 115 and upwardly connects with the limiting slot 1162. The limiting slot 1162 extends through the extending portion 115 along a front-to-back direction. An inside surface of the retaining groove 116 and an outside surface of the side wall 113 are coplanar. The limiting slot 1162 located at the right side of the base 11 extends downwardly beyond the other limiting slot 1162 located at the left side of the base 11.

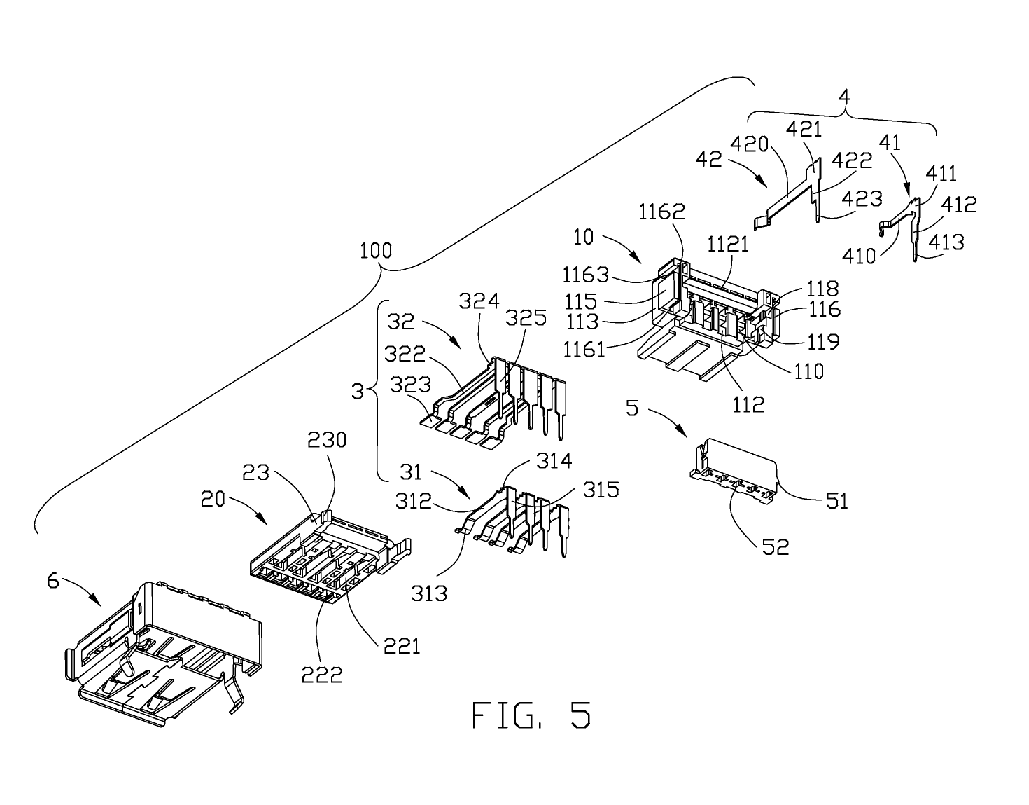

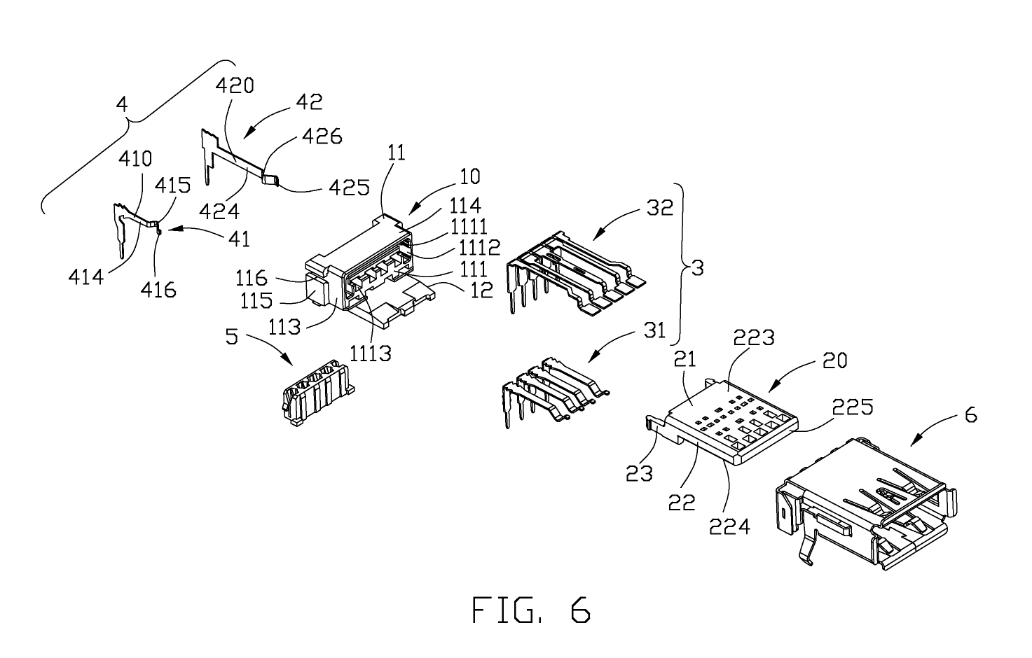

Referring to FIGS. 5-6, the second housing 20 comprises a first mounting portion 21 received in the first mounting slot 1111, a pair of second mounting portions 23 extending backwardly from the left and right side of first mounting portion 21 respectively and received in the second mounting slot 1112 and a tongue portion 22 extending forwardly from the first mounting portion 21. The second mounting portion 23 has a holding portion 230 extending outwardly from a rear end thereof and received in the holding slot 118 of the base 11. The tongue portion 22 defines a top surface 223, a bottom surface 224 opposite to the top surface 223 and a front end surface 225. The tongue portion 22 further defines a plurality of first recesses 221 and a plurality of second recesses 222 located in front of the first recesses 221.

Referring to FIG. 5, the contact 3 comprise a first contact group 31 and a second contact group 32. The first contact group 31 comprises a plurality of conductive terminals, each has a first connecting portion 312 received in the first recess 221, a first resilient contacting portion 313 extending forwardly from one end of the first connecting portion 312 and exposed to the receiving space 101, a first positing portion 314 extending backwardly from the other end of the first connecting portion 312 and retained in the first retaining slot 1113 and a first tail portion 315 extending downwardly from a rear end of the first positing portion 314.

The second contact group 32 are insert molded with the second housing 20. The second contact group 32 comprises five conductive terminals, each has a second connecting portion 322 insert molded in the second housing 20, a second stiff contacting portion 323 extending forwardly from one end of the second connecting portion 322 and retained in the second recess 222 of the tongue portion 22, a second positing portion 324 extending backwardly from the other end of the second connecting portion 322 and retained in the second retaining slot 1121 and a second tail portion 325 extending downwardly from a rear end of the second positing portion 324. Wherein the first and second contacting portions 313, 323 are commonly located at the bottom surface 224 of the tongue portion 22 and arranged in two rows along a front-to-back direction, respectively.

Referring to FIGS. 5-6, the switch contacts 4 comprise a first detecting terminal 41 retained in the retaining groove 116 on the left side of the base 11 and a second detecting terminal 42 retained in the other retaining groove 116 on the right side of the base 11. The first detecting terminal 41 is adapted for detecting whether a certain plug is inserted, the second detecting terminal 42 is adapted for detecting whether a plug is inserted. The first and second detecting terminal 41, 42 comprise a first and a second securing portions 411, 421 retained in the limiting slot 1162, respectively, a first and a second vertical portions 412, 422 extending downwardly from rear end of the first and second securing portions 411, 421, respectively, a first and a second soldering portions 413, 423 extending downwardly beyond the receiving slot 1161 from the first and second vertical portions 412, 422, respectively, and a first and a second detecting arms 410, 420 extending forwardly beyond the limiting slot 1162 from the first and second securing portions 411, 421, respectively.

The first and second detecting arms 410, 420 comprise a first and a second spring arms 414, 424 extending forwardly from the first and second securing portions 413, 423, respectively, a first and a second engaging portions 415, 425 bent forwardly into the receiving space 101 from the first and second spring arms 414, 424, respectively, and a first and a second mating portions 416, 426 extending forwardly and outwardly beyond the receiving space 101 from the first and second engaging portions 415, 425, respectively. The first and second engaging portions 415, 425 are located at left and right lateral sides of the tongue portion 22, respectively. The first securing portion 411 has a lot of barbs at an upper and a lower edges thereof to interference with the limiting slot 1162. The second securing portion 421 has a lot of barbs at upper edge thereof to interference with the limiting slot 1162.

All of lower edges of the second securing portions 421 and the first and second spring arms 414, 424 abut against bottom surfaces of the limiting slots 1162. Along an upper-to-down direction, heights of the first and second securing portions 411, 421 are equal to that of the two limiting portions 1162 on the left and right sides of the base 11, respectively; height of the first and second vertical portions 412, 422 are equal to that of the receiving slot 1161 located at the left and right sides, respectively; widths of the first and second securing portions 411, 421 are bigger than that of the first and second detecting arms 410, 420, respectively; a width of the second securing portion 421 is bigger than that of the first securing portion 411. Along the front-to-back direction, a length of the second spring arm 424 is longer than that of the first spring arm 414, in other words, the second spring arm 424 extend forwardly beyond the first spring arm 414. The second engaging portion 425 is positioned nearer to the front end surface 225 than the first engaging portion 415. The first detecting arm 410 protrudes downwardly beyond the bottom surface 224 of the tongue portion 22 while the second detecting arm 420 is located between the top surface 223 and the bottom surface 224 of the tongue portion 22 along the upper-to-down direction.

Referring to FIG. 5, the spacer 5 is upwardly assembled into the mounting space 110 of the first housing 10. The spacer 5 defines a plurality of through holes 52 along an upper-to-down direction for retaining the second tail portion 324 in the second contact group 32 and a pair of holding bump 51 protruding outwardly from two outsides thereof for mating with the latching bump 119 of the first housing 10.

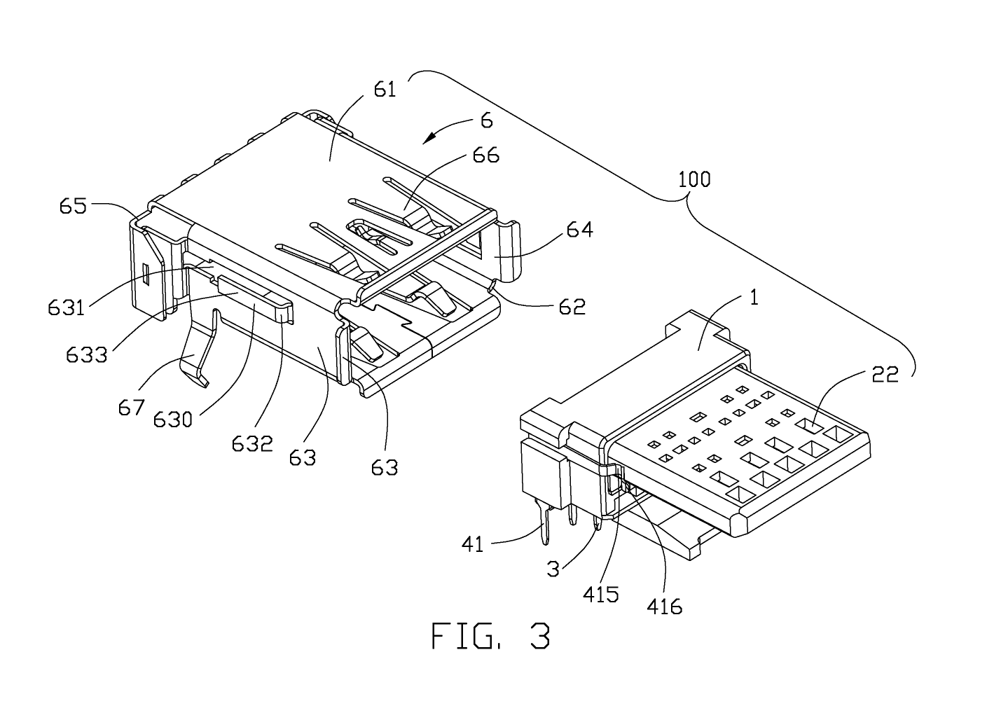

Referring to FIGS. 3-4, the shell 6 comprises an upper wall 61, a lower wall 62 opposite to the upper wall 61, a first side wall 63 at left side thereof, a second side wall 64 at right side thereof and a rear cover 65 extending downwardly from a rear end of the upper wall 61. The first and second side walls 63, 64 define a first and a second escaping spaces 631, 641 respectively, and a first and a second mating arms 630, 640 protruding outwardly beyond the first and second side wall 63, 64 respectively and corresponding to the first and second escaping spaces 631, 641 respectively. The first and second detecting arms 410, 420 are received in the first and second escaping spaces 631, 641, respectively. The first and second escaping spaces 631, 641 are formed by cutting the first and second mating arms 630, 640 respectively. The first and second escaping spaces 631, 641 each provide a deformation space for the first and second detecting arms 410 and 420. In this embodiment, the first escaping spaces 631 is an opening structure, the second escaping spaces 641 also includes some opening structures. In another embodiments, the escaping spaces 631, 641 can be substituted by a depression witch is formed by outwardly stamping the side walls 63, 64. Both the upper wall 61 and the bottom wall 62 define a plurality of spring pieces 66 extending into the receiving space 101. The first and second side walls 63 and 64 define a pair of board lockers 67 extending beyond the bottom wall 62 from rear sides thereof.

Referring to FIG. 3, the first mating arm 630 comprises a bending portion 632 extending backwardly and outwardly from a front edge of the first escaping spaces 631 and a first butting portion 633 extending horizontally and backwardly from the first bending portion 632 and located at an outside of the mating portion 416 of the first detecting terminal 41. The first mating arm 630 and the first side wall 63 are integrally stamped from as one piece metal. The first abutting portion 633 hanging outside of the first side wall 63.

Referring to FIG. 4, the second mating arm 640 comprises a convex or bulged portion 642 outwardly protruding from an inner surface of the second side wall 64 and a second abutting portion 643 extending horizontally and forwardly from the convex 642 and located at an outside of the second mating portion 426. The second mating arm 640 and the second side wall 64 are integrally of one piece. The second abutting portion 643 hangs outside of the second side wall 64.

Referring to FIGS. 3-6, in assembly, the second housing 20, in which the second contact group 32 insert molded is backwardly assembled to the first housing 10, the first and second mounting portions 21, 23 are received in the first and second mounting slots 1111, 1112 of the first housing 10 respectively, the holding portion 230 engages with the holding slot 118 for preventing the second housing 20 from forwardly moving. And then, the first contact group 31 is assembled to the first housing 10, the first connecting portion 312 is received in the first recess 221 of the tongue portion 22. Next, the first and second detecting terminals 41, 42 are forwardly assembled to the retaining slot 116 of the first housing 10. The mounting slot 1163 provides an assembly channel so as to the first and second detecting arms 410, 420 assembled to the retaining slot 116 easily. The first and second securing portions 411, 421 abut against the top and the bottom surfaces of the retaining slots 116 to ensure that the first and second detecting terminals 41, 42 are retained in the retaining slot 115 stably. Next, the spacer 5 is upwardly assembled to the receiving space 101 of the first housing 10. At last, the shell 6 is assembled to the housing 1 along the front-to-back direction, and the rear cover 65 is bent downwardly to cover the housing 1.

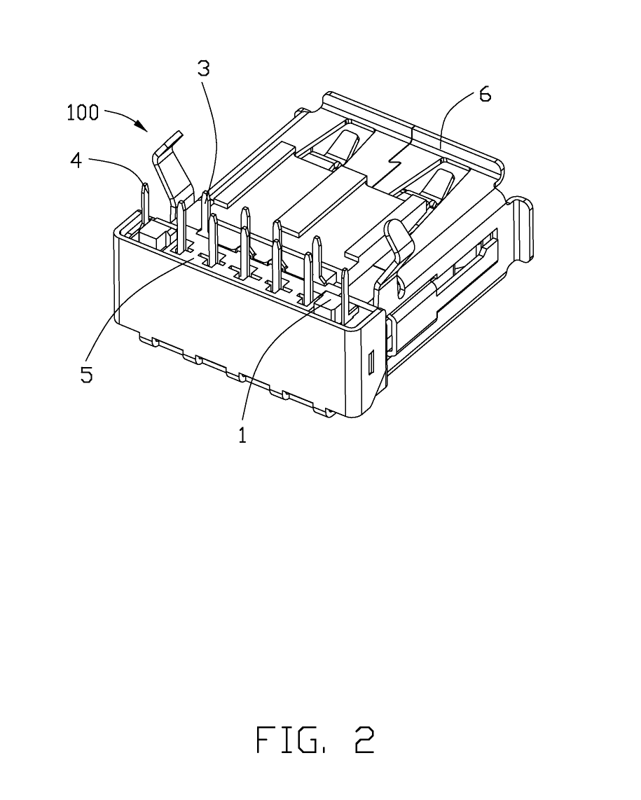

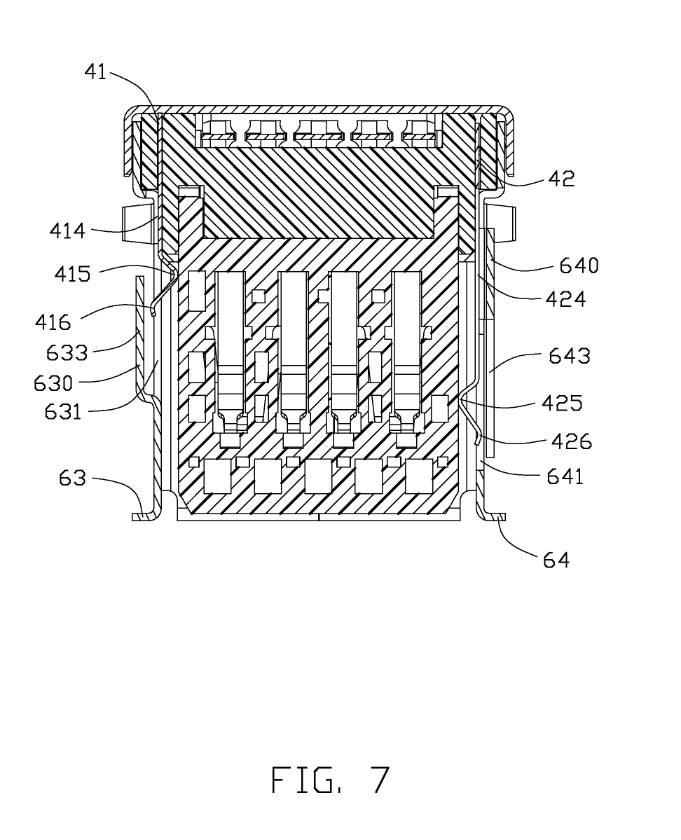

Referring to FIG. 7, the first and second engaging portions 415, 425 of the first and second detecting terminals 41, 42 abut against inwardly with left and right surfaces of the tongue 22 and are exposed to the receiving space 101. In other embodiment, the first and second engaging portions 415, 425 can keep distance with the tongue 22. The first and second mating portions 416, 426 protrudes outwardly beyond the receiving space 101 and are received in the first and second escaping spaces 631, 641 respectively and keep distance with the first and second abutting portions 633, 643 respectively. The second engaging portion 425 is positioned nearer to the front end surface 225 than the first engaging portion 415. Referring to FIGS. 2-4, the first detecting arm 410 protrudes downwardly beyond the bottom surface 224 of the tongue portion 22, while the second detecting arm 420 is located between the top surface 223 and the bottom surface 224 of the tongue portion 22 along the upper-to-down direction. The holding bump 51 at two lateral sides of the spacer 5 engages with the latching bump 119 of the first housing 10. The supporting plate 12 upwardly supports the bottom wall 62 of the shell 6.

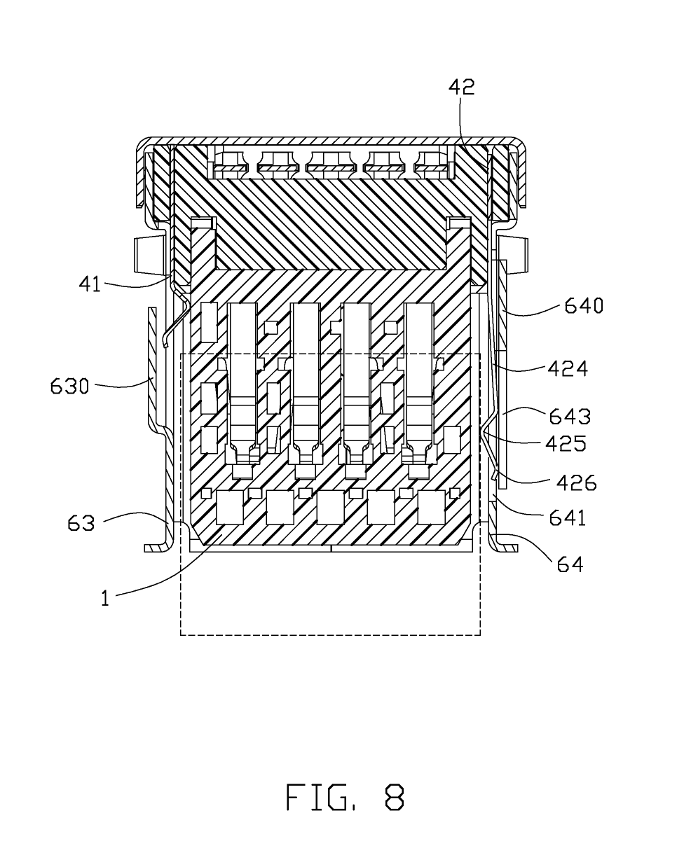

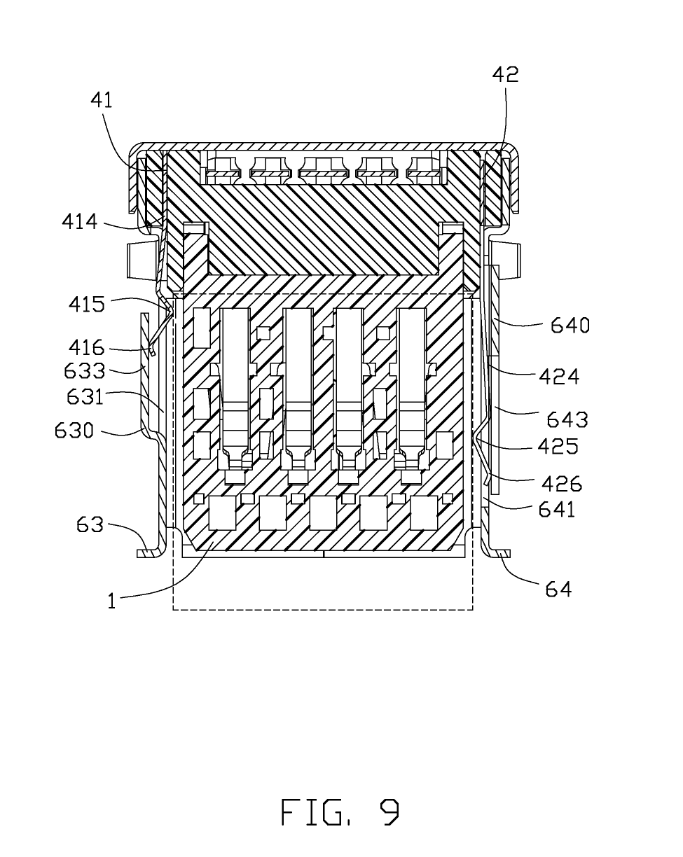

FIGS. 8-9 show different working positions of the first and second detecting terminals 41, 42 when different plugs are inserted into the electrical connector 100. FIG. 7 show an original position of the switch contacts 4. At the moment, the first and the second engaging portions 415, 425 does not contact the shell 6. Referring to FIG. 8, when an ordinary plug (not shown) with a ordinary shell is inserted into the electrical connector 100, because of the ordinary shell is too short to arrive an rear-end of the receiving space 101, the ordinary shell merely abuts against the second engaging portion 425 of the second detecting terminal 42 to make the second mating portion 426 deflect outwardly and electrically contact with the second abutting portion 643 of the shell 6. The first detecting terminal 41 keep it's original position when the ordinary plug is inserted into the electrical connector 100. Referring to FIG. 8, when a power delivery plug (not shown) with a shell which is longer than the ordinary shell is inserted into the electrical connector 100, the shell of power delivery plug arrives to the rear-end of the receiving space 101 to abut against the first and second engaging portions 415, 425 of the first and second detecting terminals 41, 42 to make the first and second mating portions 416, 426 deflect outwardly and electrically contact with the first and second abutting portions 633, 643 of the shell 6. When a thin card connector (not shown) with a longer but thinner mating portion is inserted into the electrical connector 100, the mating portion merely occupies partly receiving space located below the tongue portion 22, and the first engaging portion 415 of the first detecting terminal 41 does not protrude into the space below the tongue portion 22, hence, the mating portion of the thin card connector merely abuts against the second engaging portion 425 of the second detecting terminal 42 to make the second mating portion 426 deflects outwardly and electrically contact with the second abutting portion 643 of the shell 6.

That is obvious as well from above describe, the second engaging portion 425 of the second detecting 42 is positioned nearer to the front end surface 225 than the first engaging portion 415 of the first detecting terminal 41, and the first engaging portion 415 of the first detecting terminal 41 is located at the rear-end of the receiving space 101 and does not protrude downwardly beyond the bottom surface 224 of the tongue portion 22, as a consequence, the electrical connector 100 would detect whether a plug is inserted and further detect whether the power delivery plug is inserted to protect the electronic connector 100.

In the embodiment, the present invention is a right angle electrical connector defines the top surface 223, the bottom surface 224 and left and right sides. In other embodiments, the present invention can be designed to a reverse electrical connector, referencing to CN Pat. No. 201097427, or an upright electrical connector, referencing to CN App. No. 102117993 by simply changing the bending and extending way of the tails of the contacts. All arrangement of the first and the second detecting terminals are the same, a surface of corresponding tongue exposing the contacts is defined to be a first surface, same as the bottom surface 224 of the tongue portion 22 in present embodiment and an opposite surface is defined as to a second surface, same as to the top surface 223 of the tongue portion 22 of the electrical connector 100.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector adapted for receiving multiple kinds of mating connectors, comprising:
an insulative housing defining a base and a tongue portion extending forwardly from the base, the tongue portion having a front end surface, a first surface and a second surface opposite to the first surface;
a plurality of contacts retained in the housing;
a metal shell coving the housing, the shell and the tongue portion commonly defining a receiving space for receiving the mating connector; and
a first and a second detecting terminals located on another two opposite sides of the tongue portion respectively, and having a first and a second engaging portions extending into the receiving space, respectively; wherein
the second engaging portion of the second detecting terminal is positioned near to the front end surface of the tongue portion while the first engaging portion of the first detecting terminal is positioned on an rear-end of the receiving space and is merely adapted for electrically contacting with a certain mating connector arrived to the rear-end of the receiving space.

2. The electrical connector as claimed in claim 1, wherein the contact comprises a contacting portion exposed to the first surface of the tongue portion, the second engaging portion of the second detecting terminal protrudes beyond the first surface along a direction vertical to the first surface of the tongue, while the first engaging portion of the first detecting terminal is located inside the first surface along the same direction, so a mating connector merely drives the second detecting terminal if the mating connector merely occupies a part of the receiving space near to the first surface.

3. The electrical connector as claimed in claim 1, wherein the first and second detecting terminals further comprise a first and a second securing portions retained in housing, respectively, and a first and a second detecting arms extending forwardly from the first and second securing portions, respectively, the first and second detecting arms comprise a first and a second spring arms extending forwardly from the first and second securing portion, respectively, the first and second engaging portions are bent forwardly from the first and second spring arms, respectively, the first and second detecting arms further comprise a first and a second mating portions extending forwardly and outwardly from the first and second engaging portions, respectively; the first and second spring arms are located at two lateral outsides of the receiving space respectively, and keep a distance with the shell at an original state.

4. The electrical connector as claimed in claim 3, wherein the base has a pair of side walls located at two outsides thereof and a pair of extending portions located on outside of corresponding side walls respectively, the side walls and corresponding extending portions commonly define two retaining grooves for retaining the first and second detecting terminals, respectively, the retaining groove comprises a receiving slot extending along the first direction and a limiting slot extending along a second direction perpendicular to the first direction and located above the receiving slot, the receiving slot backwardly extends through the extending portion and connects with the limiting slot, the limiting slot extends through the extending portion along a front-to-back direction, the first and second detecting terminals are forwardly assembled to the retaining slots of the first housing, the first and second securing portions interfere with the limiting slots to ensure the first and second detecting terminals are retained in the retaining slot stably, the first and second spring arms extend forwardly beyond the base.

5. The electrical connector as claimed in claim 4, wherein the limiting slot defines a mounting slot outwardly extending through the extending portion for allowing the first and second detecting arms to get through the limiting slot.

6. The electrical connector as claimed in claim 3, wherein the shell comprises a first side wall and a second side wall facing the first and second detecting terminals, respectively, the first and second side walls define a first and a second escaping spaces respectively and a first and a second mating arms corresponding to the first and second escaping spaces and protruding outwardly beyond the first and second side walls, respectively, the first and second detecting arms are received in the first and second escaping spaces respectively, the first and second mating portions electrically contact with the first and second mating arms to achieve a detecting function on condition that the mating connector drives the first and second detecting arms outwardly deflect, one of the first and second escaping spaces is an opening structure.

7. The electrical connector as claimed in claim 6, wherein the first mating arm comprises a bending portion extending backwardly and outwardly from a front edge of the first escaping spaces and a first butting portion extending horizontally and backwardly from the first bending portion and located at an outside of the mating portion of the first detecting terminal.

8. The electrical connector as claimed in claim 7, wherein the second mating arm comprises a convex protruding outwardly from an inner surface of the second side wall and a second abutting portion extending horizontally and forwardly from the convex and located at an outside of the second mating portion.

9. The electrical connector as claimed in claim 1, wherein the electrical connector is USB 3.0 receptacle, the contact comprises a first contact group comprising a first resilient contacting portion and a second contact group comprising a second stiff contacting portion, both the first and second contacting portions are located on the first surface of the tongue portion and are arranged in two rows along a length direction of the tongue portion.

10. The electrical connector as claimed in claim 1, wherein the housing comprises a first housing in which the base is located and a second housing backwardly assembled to the first housing, the tongue portion is located in the second housing, the first and second housing define a lock mechanism to lock with each other.

11. An electrical connector, comprising:
a plurality of contacts having a row of first contacts and another row of second contacts;
an insulative housing having a base and a tongue portion extending forwardly from the base, the tongue portion having a front end surface away from the base and a first surface exposing the contacts,
a metal shell enclosing the housing, the shell and the tongue portion commonly defining a receiving space for receiving a mating connector; and
a first detecting terminal retained in the housing with a first securing portion retained in the base and a first engaging portion extending forwardly into the receiving space from the first securing portion; wherein
the first engaging portion of the first detecting terminal is positioned on an rear-end of the receiving space and is merely adapted for electrically contacting with a certain mating connector reaching the rear-end of the receiving space, the shell having a first side wall, corresponding to the first detecting terminal, defining a first escaping space to provide a deformation space for the first engaging portion, the first escaping space is a depression witch is formed by outwardly stamping the first side wall.

12. The electrical connector as claimed in claim 11, wherein further comprising a second detecting terminal with a second securing portion and a second engaging portion extending forwardly from the second securing portion and is positioned near to the front end surface than the first engaging portion, the second engaging portion of the second detecting terminal protrudes beyond the first surface while the first engaging portion of the first detecting terminal is located inside the first surface along a first direction perpendicular to the first surface.

13. The electrical connector as claimed in claim 12, wherein the first and second detecting terminals further comprise a first and a second mating portions extending forwardly and outwardly from the first and second engaging portions, respectively; the first and second detecting terminals are located at two lateral outsides of the receiving space, respectively, and keep a distance with the shell at an original state.

14. The electrical connector as claimed in claim 13, wherein the base has a pair of side walls located at two outsides thereof and a pair of extending portions located on outside of the side walls respectively, the side walls and corresponding extending portions commonly define two retaining grooves for retaining the first and second detecting terminals respectively, the first and second securing portions interference with the retaining grooves to ensure the first and second detecting terminals are retained in the retaining slot stably, the first and second engaging portions extend forwardly beyond the retaining grooves respectively.

15. The electrical connector as claimed in claim 14, wherein the shell further comprises a second side wall opposite to the first side wall, the second side walls defines a second escaping spaces to provide a deformation space for the first engaging portion, the first and the second side walls further comprise a first and second abutting portions, the first and second mating portions electrically contact with the first and second abutting portions to achieve a detecting function on condition that the mating connector drives the first and second detecting arms outwardly deflect.

16. An electrical connector for use with a plug, comprising:
an insulative housing with a forwardly extending mating tongue in a front-to-back direction;
a plurality of contacts disposed in the housing with contacting sections exposed upon the mating tongue;
a metallic shell enclosing said insulative housing and defining a rectangular mating port surrounding said mating tongue, said rectangular mating port defined by a plurality of side walls of said metallic shell and dimensioned to be essentially conformable to a contour of said plug connector, a plurality of spring tangs on one of said side walls and deflectable in a transverse direction perpendicular to said front-to-back direction in response to insertion of said plug connector, and at least one outwardly and transversely bulged portion formed on one of said side walls to form an escaping space inside of said bulged portion to face the rectangular mating port; and
a detect terminal disposed in the housing with a resilient contacting section extending into the mating port and proximate said escaping space; wherein
when the plug connector is inserted into the mating port, the detect terminal is initially mechanically and electrically connected to and outwardly deflected by another shell of the plug connector and successively entering said escaping space and eventually contacting the bulged portion to perform detection effect.

17. The electrical connector as claimed in claim 16, wherein the side wall where the spring tangs are located, is perpendicular to and neighboring to the side wall where the bulged portion is formed, while both said two side walls are transverse to said mating port.

18. The electrical connector as claimed in claim 17, wherein said shell further defines another outward and transverse bulged portion opposite to, in another transverse direction perpendicular to said transverse direction, said bulged portion with another escaping space, and another detect terminal is disposed in the housing with another contacting section entering said another escaping space in response to the insertion of the plug connector, and said bulged portion and said another bulged portion are located offset from each other in the front-to-back direction.

19. The electrical connector as claimed in claim 16, wherein the bulged portion includes a cantilevered arm extending along the front-to-back direction, against which said detect terminal abuts.

20. The electrical connector as claimed in claim 19, wherein said shell further includes another bulged portion transversely opposite to said bulged portion and leaving another escaping space inside with another cantilevered arm extending along said front-to-back direction to use with another detect terminal disposed in the housing, the bulged portion located in front of said another bulged portion in said front-to-back direction, and the cantilevered arm extending forward while said another cantilevered arm extending rearwardly.
